(19) United States
(12) Patent Application Publication
(10) Pub. No.: US 2005/0048886 A1
(43) Pub. Date: Mar. 3, 2005

(54) Net loader

(75) Inventor: Ennio Mercuri, Burnside (AU)

Correspondence Address: CROWELL & MORING LLP;INTELLECTUAL PROPERTY GROUP, P.O. BOX 14300, WASHINGTON, DC, 20044-4300, US

(73) Assignee: Merctech Pty Ltd., Holden Hill (AU)

(21) Appl. No.: 10/924,838

(22) Filed: Aug. 25, 2004

(30) Foreign Application Priority Data
Aug. 28, 2003 (AU) 2003904652

(51) Int. Cl. A22C 13/02

(52) U.S. Cl. 452/35

(57) ABSTRACT

A device for filling tubular casings with edible material is disclosed. The device includes a tube upon which the casing can be shirred onto, a tube inlet, a tube outlet and tube support means. The support means allows the device to be supported for the manual insertion of edible material into the tube inlet and furthermore the manual forcing of this edible material through the tube and out of the tube outlet.

### FIELD OF THE INVENTION

The present invention relates to the manufacture of food products. In one particular form, the present invention relates to equipment involved in the manufacturing of meat products.

### BACKGROUND OF THE INVENTION

In the manufacture of food products, and in particular in respect of the manufacture of meat products, natural or artificial casings in the form of elongated tubes are normally pumped full of meat from a filling machine specifically designed for this purpose. These machines pump or force meat through a stuffing tube over whose external surface a tubular casing has been shirred onto. The meat is thus extruded under pressure from the stuffing tube into the casing which is first clipped and closed at one end, drawing the casing off the stuffing tube in the process. Depending on the desired length of the meat product, the process is interrupted at various stages so that clips or twists may be applied to form separate and individual meat product portions.

These filing machines can be used either with minced meat products, meat portions or whole meat muscle and the means used to force the meat through the stuffing tube includes a hydraulically or pneumatically forced piston ram or alternatively, in the case of minced or chopped meat, by direct pumping. The tubular casing is typically shirred onto the stuffing tubes as a separate first step. The stuffing tube is then attached to the outlet port of the filling machine using either a screw thread or pin bayonet arrangement. As can be readily appreciated, these filling machines represent a significant capital expense. Often only small batch amounts are contemplated and the additional overhead of configuring and loading a filling machine makes these small batches relatively costly when compared to larger amounts.

It is therefore an object of the present invention to provide a device which allows for the efficient stuffing of casings in small batches or by hand.

### SUMMARY OF THE INVENTION

In a first aspect the present invention accordingly provides a device for filling tubular casings with edible material, said device including:
a tube upon which said casing can be shirred onto;
a tube inlet;
a tube outlet; and
tube support means, wherein said support means support the device for manual insertion of said edible material into said tube inlet and manual forcing of said edible material through said tube and out of said tube outlet.

As the device is simple to manufacture and is manually operated there is no requirement for sophisticated and, expensive filling machines making it ideal for preparing small batches.

Preferably said tube inlet is adapted to allow substantially full insertion of an arm into said tube. This allows a large amount of pressure to be generated on the contents of the tube. In addition, this will facilitate cleaning of the device which is always important in the preparation of food products.

Preferably said tube includes mounting means to rigidly mount said device when shirring said tubular casing onto said tube. This will facilitate the shirring operation considerably which in turn makes the overall process more convenient and efficient.

In a second aspect the invention accordingly provides a method for manually stuffing edible material into tubular casing, said method including the steps of:
shirring said casing onto a tube having a tube inlet and a tube outlet, leaving an end section of said casing extending from said tube outlet;
supporting said tube, and
manually inserting edible material into the tube inlet and forcing said edible material through said tube and out said tube outlet into said casing.

The end section of the casing may be closed by clipping (for example) or may be left open.

### BRIEF DESCRIPTION OF THE DRAWINGS

An illustrative embodiment of the present invention will be discussed with reference to the accompanying drawings wherein:

FIG. 1 is a side view of a manual stuffing tube according to a preferred embodiment of the present invention.

FIG. 2 is a top view of the stuffing tube illustrated in FIG. 1.

FIG. 3 is a cross-sectional view of the stung tube illustrated in FIG. 1 when viewed from the tube inlet end.

FIG. 4 is a perspective view of a device for automatically shirring casing onto the manual stuffing tube illustrated in FIG. 1.

FIG. 5 is a side view of the device illustrated in FIG. 4 depicting the interference sleeve.

### DESCRIPTION OF PREFERRED EMBODIMENT

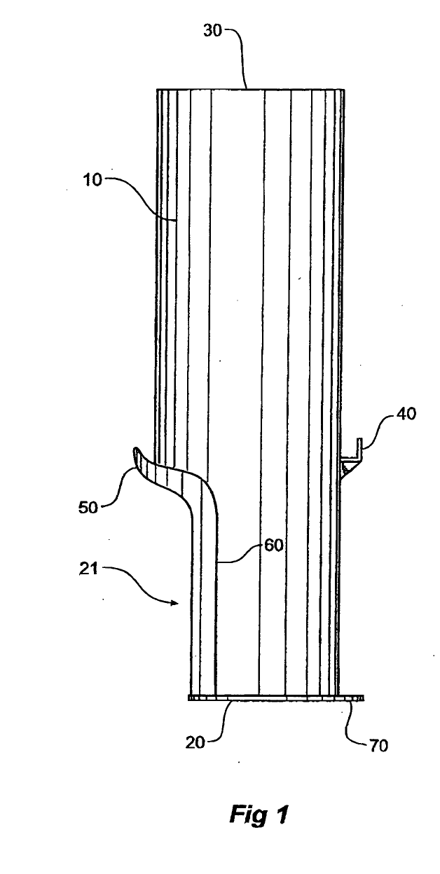

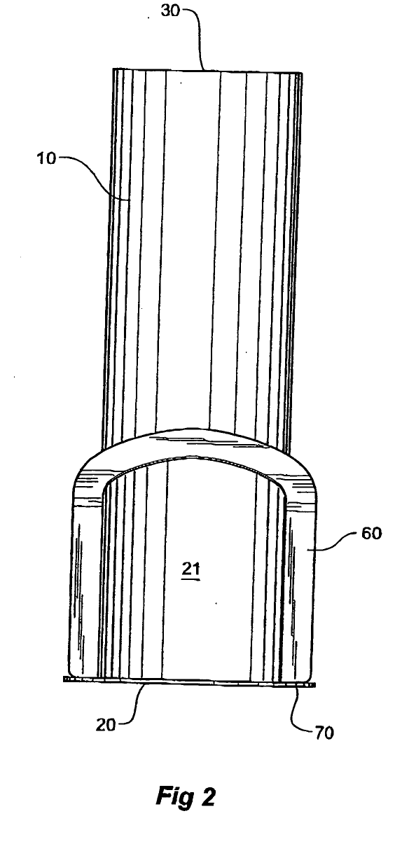

Referring now to FIGS. 1 and 2, there is shown a preferred embodiment of the invention suitable for stuffing meat products into tubular casing including: a tube 10 having a tube inlet 20 and tube outlet 30. As would be appreciated by those skilled in the art, the invention may be used to stuff other edible materials having a similar physical consistency. Tube 10, in this preferred embodiment, is constructed from 3 mm stainless steel but other material equally suitable for handling food such as various plastics may be employed. In addition, whilst tube 10 in this preferred embodiment has a circular cross section, other non regular cross sections that allow for the transferring of material through the tube are considered to be within the scope of the invention. Tube 10 has a diameter of 150 mm and a length of 850 mm.

Tube inlet 20 includes a section 21 having a length of 200 mm and depth of 30 mm cut away from a top area of the cylinder. As the length of the tube is longer than that of the average arm, cut away section 21 allows the operator of the stuffing tube to gain greater penetration with a hand or any other manually operated plunger device.

Attached to the periphery of section 21 is a lip 60 of 20 mm width, also of stainless steel. Lip 60 is incorporated as a safety measure which ensures that the operator of the manual stuffing tube will not encounter any sharp edges. As a secondary function, lip 60 also facilitates the insertion of material into the tube. As this embodiment is designed to be operated in a vertical position, tube 10 also includes an angle bracket 40 attached to the exterior of the cylinder. Diametrically opposed to bracket 40 a protruding section 50 of the lip 60 also forms a separate support, so that tube 10 may be mounted on a frame with outlet end 30 pointing downwards. Clearly, the invention is not limited to a vertical orientation and therefore other types of support means which allow orientation of the stuffing tube 10 in a horizontal or other inclined position are considered to be within the scope of the invention.

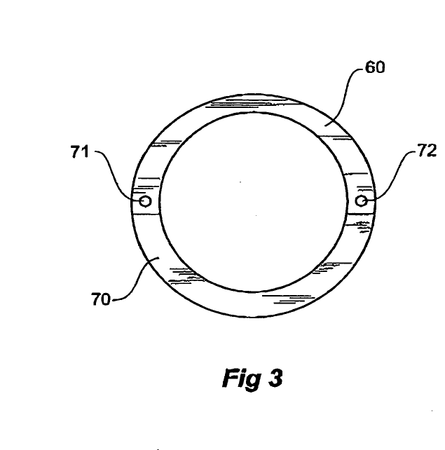

Inlet end 20 also includes a flange 70 of width 15 mm which is formed to join with lip 60. Referring now to FIG. 3, there is shown a cross sectional view of the stuffing tube depicted in FIGS. 1 and 2 showing holes 71 and 72 in the flange. In operation, tube 10 will be mounted using these holes to a rigid support and casing shirred onto the exterior of tube 10 either manually or by specialised apparatus. When shirring, angle bracket 40 and lip section 50 also form a convenient abutment region for the casing material. After shirring has been completed, the casing is clipped at one end and the tube 10 is mounted using bracket 40 to a mounting frame. In a preferred embodiment, the mounting frame includes inclined slots allowing tube 10 to be mounted at predetermined inclinations. Typically, tube 10 will be mounted vertically initially. Suitably prepared meat products are then continuously manually inserted at the inlet end 20, thereby forcing these products through tube 10 and extruding them from outlet end 30 into the casing which is drawn off in the process. This operation generally requires two people, the first person inserting the goods into tube 10, and the second person helping to urge the casing off the tube where necessary and clipping it to form discrete meat product portions.

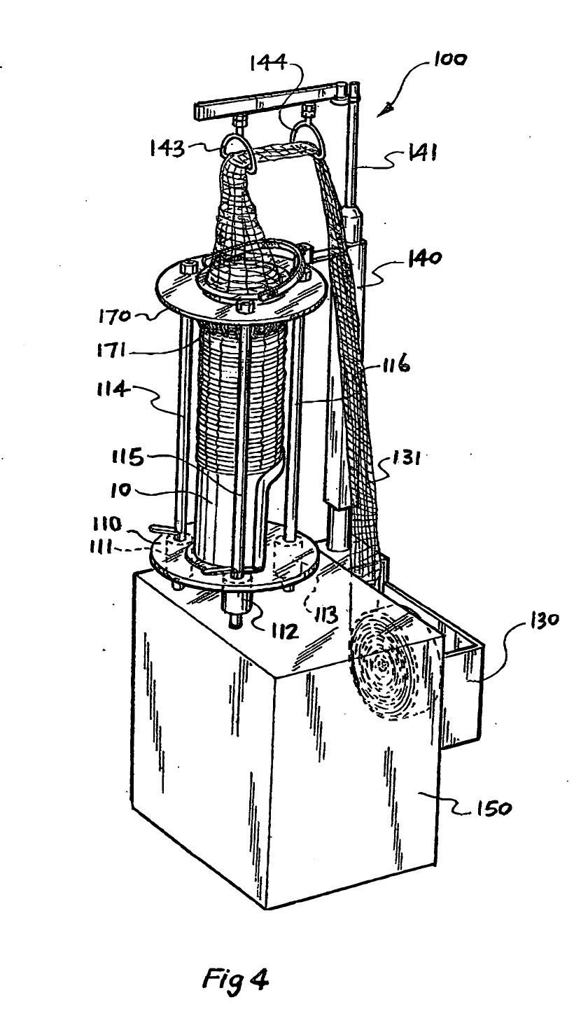

Refuting now to FIG. 4, there is illustrated a casing loader 100 for shirring casing on tube 10. Casing loader 100 includes a base section 150 which incorporates pneumatic and control systems. In addition, base section 150 includes casing storage and dispensing compartment 130 which contains casing 131 rolled flat to form a cylinder for easy dispensing during shirring operation. Tube 10 is fixedly mounted onto platform 110 using holes 71, 72 (see FIG. 3) using suitable retaining nuts. Platform 110 is slidable on column supports 114, 115, 116 by pneumatic lifting sections 111, 112, 113. At the top of column supports 114, 115, 116 is located shirrer 170 which includes a number of fingers 171 which bias towards tube 10 to grip and shir casing 131 onto tube 10 as it is moved upwards due to movement of platform 110. On downwards movement of platform 110, fingers 171 release from tube 10 allowing more casing 131 to be dispensed as tube 10 moves downwards. To ensure casing 131 does not tangle when being shirred, casing loader 100 includes side arm 140 which includes retractable portion 141 further including hanging guide members 143 and 144 through which casing 131 is threaded.

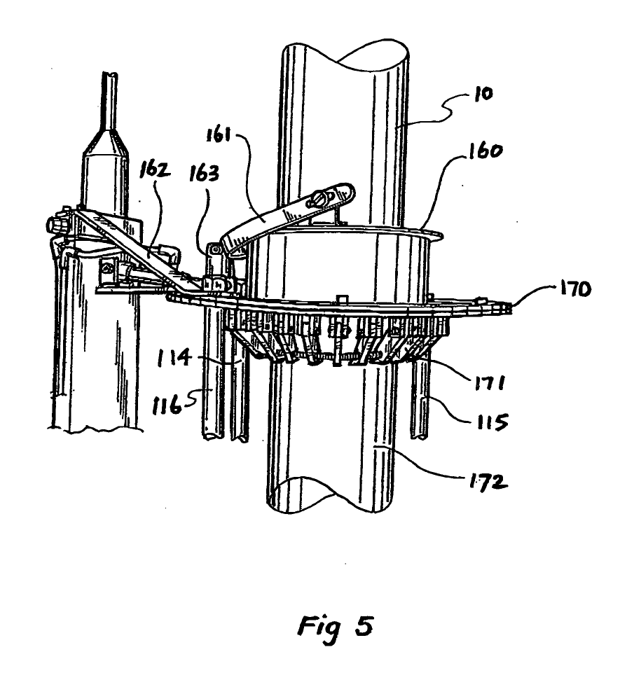

FIG. 5 illustrates shirrer 170 in more detail, showing interference sleeve 160 which when inserted into shirrer 170, opens fingers 171 outwards to allow initial insertion of tube 10 into the shirrer 170. After tube 10 is mounted, interference sleeve 160 is retracted using pivotable horseshoe arm 161, which pivots about hinge 163 to raise sleeve 160 from shirrer 170 so that shirring operation may commence. Sleeve 160 is of sufficient diameter to allow clearance for the casing to be shirred onto tube 10.

Referring now to FIGS. 1 to 5, to load casing onto tube 10, first a mandible (not shown) is fitted to tube outlet 30 and an initial portion of casing 131 is threaded through guide members 143, 144 through interference sleeve 160 which has been inserted into shirrer 170 and onto tube 10. Tube 10 is then inserted into shirrer 170, which is possible as fingers 171 are held outwards from tube 10 by interference sleeve 160. Tube 10 is then fixed to platform 110 as described previously. Interference sleeve 160 is then removed from shirrer 170, allowing fingers 171 to move inwards and engage the initial portion of casing 131 onto tube 10.

Platform 110 is moved upwards by pneumatic lifting sections 111, 112, 113 and guided by columns 114, 115, 116 thus also raising tube 10 through shirrer 170. Fingers 171 engage the casing 131 and drive it down to bracket 40 and protruding lip section 60 as tube 10 is raised. This prevents casing 131 from moving further down tube 10 towards inlet end 20. After completion of the upstroke, platform 110 moves downwards and fingers 171 release from tube 10, allowing further casing to be drawn from casing storage and dispensing compartment 130. Shirred casing 180 is thus shirred onto tube 10. This process is repeated until a suitable amount of casing 131 is shirred onto tube 10 at which point tube 10 may be removed from casing loader 100, the mandible removed and casing 131 then tied off at the outlet end before commencing stuffing of the tube.

It will be understood that the term “comprise” and any of its derivatives (eg. comprises, comprising) as used in this specification is to be taken to be inclusive of features to which it refers, and is not meant to exclude the presence of any additional features unless otherwise stated or implied.

Although a preferred embodiment of the method and apparatus of the described in the foregoing detailed description, it will be understood that the invention is not limited to the embodiment disclosed, but is capable of numerous rearrangements, modifications and substitutions without departing from the scope of the invention as set forth and defined by the following claims.

1. A device for filling tubular casings with edible material, said device including:
a tube upon which said casing can be shirred onto;
a tube inlet;
a tube outlet; and
tube support means, wherein said support means support the device for manual insertion of said edible material into said tube inlet and manual forcing of said edible material through said tube and out of said tube outlet.

2. A device for filling tubular casings with edible material as claimed in claim 1 wherein said tube inlet is adapted to allow substantially full insertion of an arm into said tube.

3. A device for filling tubular casings with edible material as claimed in claim 2 wherein said tube inlet includes a lip located on a periphery of said tube inlet

4. A device for filling tubular casings with edible material as claimed in claim 1 wherein said tube is cylindrical.

5. A device for filling tubular casings with edible material as claimed in claim 1 wherein said support means is located on an outer surface of said tube.

6. A device for filling tubular casings with edible material as claimed in claim 1 wherein said tube includes mounting means to rigidly mount said device when shirring said tubular casing onto said tube.

7. A device for filling tubular casings with edible material as claimed in claim 6, wherein said mounting means allows mounting of said device at a plurality of orientations.

8. A method for manually stuffing edible material into tubular casing, said method including the steps of
shirring said casing onto a tube having a tube inlet and a tube outlet, leaving an end section of said casing extending from said tube outlet,
supporting said tube, and
manually inserting edible material into the tube inlet and forcing said edible material through said tube and out said tube outlet into said casing.
